(19) United States
(12) Patent Application Publication
(10) Pub. No.: US 2013/0023634 A1
(43) Pub. Date: Jan. 24, 2013

(54) CATALYST SYSTEM BASED ON QUINOLINE DONORS

(71) Applicants: Sandor NAGY, Naperville, IL (US); Llya E. Nifantev, Moscow (RU); Karen L. Neal-Hawkins, Cincinnati, OH (US); Shahram Mihan, Bad Soden (DE)

(72) Inventors: Sandor NAGY, Naperville, IL (US); Llya E. Nifantev, Moscow (RU); Karen L. Neal-Hawkins, Cincinnati, OH (US); Shahram Mihan, Bad Soden (DE)

(21) Appl. No.: 13/185,183

(22) Filed: Jul. 18, 2011

(51) Int. Cl. C08F 4/76; C08F 10/02; C08F 4/65; C08F 2/00

(52) U.S. Cl. 526/131; 502/167; 502/118; 502/62

(57) ABSTRACT

A catalyst system obtainable with a process comprising the following steps:
i) contacting a group 4 metal compound of formula (I)

MX₄ (I)
wherein M is a metal of group 4 of the periodic table of the element, and X is a halogen atom or an organic radical;
with a compound of formula (II)

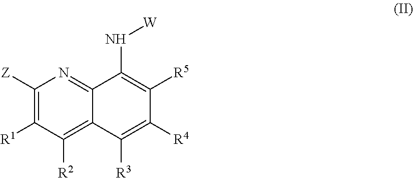

ii) adding to the reaction mixture of step i) one or more boron compounds having Lewis acidity wherein the molar ratio between the boron compound and the compound of formula (I) ranges from 0.9 to 100;
iii) adding the reaction mixture obtained in step ii) to a silica support.

with the proviso that the catalyst system is not treated with alumoxanes.

### FIELD OF THE INVENTION

The invention relates to catalyst system comprising a quinoline-based donor useful for polymerizing olefins.

### BACKGROUND OF THE INVENTION

While Ziegler-Natta catalysts are a mainstay for polyolefin manufacture, single-site (metallocene and non-metallocene) catalysts represent the industry's future. These catalysts are often more reactive than Ziegler-Natta catalysts, and they produce polymers with improved physical properties. The improved properties include controlled molecular weight distribution, reduced low molecular weight extractables, enhanced incorporation of alpha-olefin comonomers, lower polymer density, controlled content and distribution of long-chain branching, and modified melt rheology and relaxation characteristics. Traditional metallocenes incorporate one or more cyclopentadienyl (Cp) or Cp-like anionic ligands such as indenyl, fluorenyl, or the like, that donate pi-electrons to the transition metal. Non-metallocene single-site catalysts, including ones that capitalize on the chelate effect, have evolved more recently. Examples are the bidentate 8-quinolinoxy or 2-pyridinoxy complexes of Nagy et al. (see U.S. Pat. No. 5,637,660), the late transition metal bisimines of Brookhart et al. (see Chem. Rev. 100 (2000) 1169), and the diethylenetriamine-based tridentate complexes of McConville et al. or Shrock et al. (e.g., U.S. Pat. Nos. 5,889,128 and 6,271,323).

In numerous recent examples, the bi- or tridentate complex incorporates a pyridyl ligand that bears a heteroatom β- or γ- to the 2-position of the pyridine ring. This heteroatom, typically nitrogen or oxygen, and the pyridyl nitrogen chelate the metal to form a five- or six-membered ring. For some examples, see U.S. Pat. Nos. 7,439,205; 7,423,101; 7,157,400; 6,653,417; and 6,103,657 and U.S. Pat. Appl. Publ. Nos. 2008/0177020 and 2010/0022726. In some of these complexes, an aryl substituent at the 6-position of the pyridine ring is also available to interact with the metal through C—H activation to form a tridentate complex (see, e.g., U.S. Pat. Nos. 7,115,689; 6,953,764; 6,706,829).

Less frequently, quinoline-based bi- or tridentate complexes have been described. The tridentate complexes typically lack an 8-anilino substituent, a 2-imino or 2-aminoalkyl substituent, or both. For example, U.S. Pat. Nos. 7,253,133 (col. 69, complex A-6) and 7,049,378 (col. 18, Example 2) disclose multidentate complexes that can incorporate a quinoline moiety, but the quinoline is not substituted at the 2-position and is not substituted at the 8-position with an anilino group. U.S. Pat. No. 6,939,969 describes bi- and tridentate quinoline-containing ligands, and at least one early transition metal complex (col. 20, Example 6) is disclosed. Complexes having an 8-anilino substituent are described, but none of the quinoline ligands are substituted with 2-imino or 2-aminoalkyl groups. U.S. Pat. No. 6,103,657 teaches bidentate complexes from quinoline ligands having a 2-imino group (Table 2, Example 5c). The complexes also lack an 8-anilino substituent.

All these catalyst systems are mainly based on organometallic complexes that have to be synthesized and purified before the use and that sometimes are not stable for long time. Otherwise these catalyst system are based on alumoxanes that are quite expensive. The applicant now found a catalyst system that can be prepared in situ able to giving high yields without the use of alumoxanes.

### SUMMARY OF THE INVENTION

The invention relates to catalyst system useful for polymerizing olefins. The catalysts comprise a transition metal complex, an activator, and a support. The complex is the reaction product of a Group 3-6 transition metal source, an optional alkylating agent, and a ligand precursor comprising a 2-imino-8-anilinoquinoline or a 2-aminoalkyl-8-anilinoquinoline. The ligand precursor has three nitrogens available to coordinate to the metal in the resulting complex. The catalysts are easy to synthesize by in-situ metallation of the ligand precursor, and they offer polyolefin manufacturers good activity and the ability to make high-molecular-weight ethylene copolymers that have little or no long-chain branching.

### DETAILED DESCRIPTION OF THE INVENTION

An object of the present invention is a catalyst system obtainable with a process comprising the following steps:

i) contacting a group 4 metal compound of formula (I)

MX₄ (I)
wherein M is a metal of group 4 of the periodic table of the element, preferably M is titanium, zirconium or hafnium, more preferably M is zirconium, and X, equal to or different from each other, is a halogen atom, a R, OR, SR, NR₂ or PR₂ group wherein R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; or two X groups can be joined together to form a divalent R′ group wherein R′ is a C₁-C₂₀-alkylidene, C₆-C₂₀-arylidene, C₇-C₂₀-alkylarylidene, or C₇-C₂₀-arylalkylidene divalent radical optionally containing heteroatoms belonging to groups 13-17 of the Periodic Table of the Elements; preferably X is a halogen atom or R group; more preferably X is halogen or a C₇-C₄₀-alkylaryl radical such as benzyl radical; with a compound of formula (II)

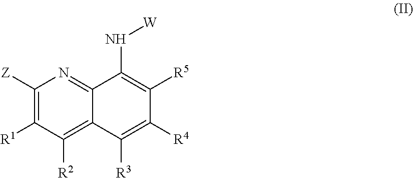

wherein:
   W is a C₆-C₄₀-aryl radical that can be substituted with one or more G group wherein G, equal to or different from each other, are linear or branched C₁-C₄₀-alkyl, C₂-C₄₀ alkenyl, C₂-C₄₀ alkynyl radicals; preferably W is a phenyl radical substituted in position 2 and 6 by G groups, more preferably W is a phenyl radical substituted in positions 2 and 6 with linear or branched C₁-C₄₀-alkyl radicals; preferred alkyl radicals are methyl, ethyl, propyl, isopropyl, tert-butyl radicals;
R¹, R², R³, R⁴ and R⁵, equal to or different from each other, are hydrogen atoms or C₁-C₄₀ hydrocarbon groups optionally containing one or more heteroatoms belonging to groups 13-17 of the Periodic Table of the Elements; preferably R¹, R², R³, R⁴ and R⁵ equal to or different from each other, are hydrogen atoms or linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radicals, optionally containing one or more heteroatoms belonging to groups 13-17 of the Periodic Table of the Elements; more preferably R¹, R², R³, R⁴ and R⁵ are hydrogen atoms;
Z is selected from moiety of formula (IIa) or (IIb)

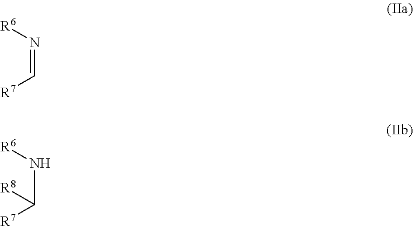

Wherein
R⁶ and R⁷ equal to or different from each other, are C₁-C₄₀ hydrocarbon groups optionally containing one or more heteroatoms belonging to groups 13-17 of the Periodic Table of the Elements; or R⁶ and R⁷ can be joined to form a a C₃-C₂₀ membered ring that can be aliphatic or aromatic and one or more carbon atoms of the ring can be optionally substituted with heteroatoms belonging to groups 13-16 of the Periodic Table of the Elements, and can have on its turn C₁-C₄₀ hydrocarbon substituents; preferably R⁶ and R⁷ equal to or different from each other, are linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radicals, optionally containing one or more heteroatoms belonging to groups 13-17 of the Periodic Table of the Elements;
more preferably R⁶ is a C₆-C₂₀-aryl, C₇-C₇₀-alkylaryl or C₇-C₂₀-arylalkyl radical, such as a phenyl radical substituted in position 2 and 6 by a C₁-C₂₀-alkyl radical such as methyl, ethyl, propyl, isopropyl, tert-butyl radical;
more preferably R₇ is a C₁-C₂₀-alkyl radical, such as methyl, ethyl, propyl, isopropyl, tert-butyl radical;
R⁸ is hydrogen atom or C₁-C₄₀ hydrocarbon groups optionally containing one or more heteroatoms belonging to groups 13-17 of the Periodic Table of the Elements; preferably R⁸ is a hydrogen atom or a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radicals, optionally containing one or more heteroatoms belonging to groups 13-17 of the Periodic Table of the Elements; more preferably R⁸ is hydrogen atom or a C₁-C₂₀-alkyl radical such as methyl, ethyl, propyl, isopropyl, tert-butyl radical;
wherein the molar ratio between (I) and (II) are from 0.5 to 2, more preferably from 0.8 to 1.5, and most preferably from 0.9 to 1.1
ii) adding to the reaction mixture of step i) one or more boron compounds having Lewis acidity wherein the molar ratio between the boron compound and the compound of formula (I) ranges from 0.9 to 100; preferably from 0.9 to 10; more preferably from 0.9 to 5;
iii) adding the reaction mixture obtained in step ii) to a support.
   with the proviso that the catalyst system is not treated with alumoxanes.

Optionally the catalyst system object of the present invention can be treated before the use with organo-aluminium compound of formula HⱼAlU₃₋ⱼ or HⱼAl₂U₆₋ⱼ, where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number.

Boron compounds having Lewis acidity include organoboranes, organoboronic acids, organoborinic acids, and the like. Specific examples include lithium tetrakis(pentafluorophenyl)borate, anilinium tetrakis(pentafluorophenyl)-borate, trityl tetrakis(pentafluorophenyl)borate (“F20”), tris(pentafluorophenyl)-borane (“F15”), triphenylborane, tri-n-octylborane, bis(pentafluorophenyl)borinic acid, pentafluorophenylboronic acid, and the like. These and other suitable boron-containing activators are described in U.S. Pat. Nos. 5,153,157, 5,198,401, and 5,241,025, the teachings of which are incorporated herein by reference.

Preferably the compound of formula (II) has formula (IIIa) or (IIIb)

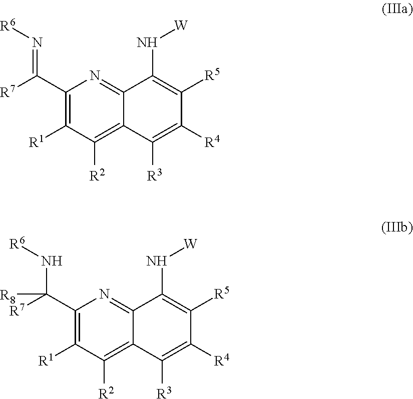

Wherein R¹, R², R³, R⁴, R⁵, R⁶, R⁷, R⁸ and W have been described above

More preferably the compound of formula (IIa) has formula (IV)

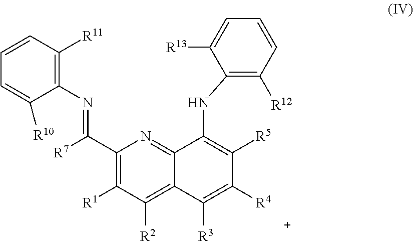

Wherein R¹, R², R³, R⁴, R⁵ have been described above and R¹⁰, R¹¹, R¹² and R¹³, equal to or different from each other, are hydrogen atoms or C₁-C₂₀ alkyl radicals, preferably R¹⁰ and R¹¹, equal to or different from each other, are C₁-C₁₀ alkyl radicals such as methyl, ethyl, propyl, isopropyl, tert-butyl radicals; preferably R¹² and R¹³, equal to or different from each other, are hydrogen atoms or C₁-C₁₀ alkyl radicals such as methyl, ethyl, propyl, isopropyl, tert-butyl radicals.

Preferably in the compound of formula (IV) R¹⁰ and R¹¹ are CH(R¹⁴)₂ radicals wherein R¹⁴ is a C₁-C₄ alkyl radical such as isopropyl; R⁷ is a C₁-C₅ alkyl alkyl radical and R¹² and R¹³, equal to or different from each other, are C₁-C₁₀ alkyl radicals;

The compound of formula (II) can be synthesized by any convenient method. In one valuable approach, a 2,8-dihaloquinoline is used as a starting material as illustrated below in the examples preparation of Precursor 1. Palladium-promoted substitution of a lithium enolate for the 2-bromo group provides, upon workup, an acetyl group at the 2-position. This is readily converted to the corresponding 2-imino compound by reaction with an amine, usually an aniline compound, to form the Schiff base compound. Palladium-catalyzed coupling can then be used to replace the halogen at the 8-position of the quinoline ring with an anilino group.

Compounds of formula (II) are described in U.S. patent application Ser. No. 12/804,122 the teachings of which are incorporated herein by reference.

In step (iii) the catalyst systems obtainable with the process of the present invention are supported on a support; preferably the support is an inorganic oxide such as silica, alumina, silica-alumina, magnesia, titania, zirconia, clays, zeolites, or the like. Silica is preferred. When silica is used, it preferably has a surface area in the range of 10 to 1000 m²/g, more preferably from 50 to 800 m²/g and most preferably from 200 to 700 m²/g. Preferably, the pore volume of the silica is in the range of 0.05 to 4.0 mL/g, more preferably from 0.08 to 3.5 mL/g, and most preferably from 0.1 to 3.0 mL/g Preferably, the average particle size of the silica is in the range of 1 to 500 microns, more preferably from 2 to 200 microns, and most preferably from 2 to 45 microns. The average pore diameter is typically in the range of 5 to 1000 angstroms, preferably 10 to 500 angstroms, and most preferably 20 to 350 angstroms.

The support is preferably treated thermally, chemically, or both prior to use by methods well known in the art to reduce the concentration of surface hydroxyl groups. Thermal treatment consists of heating (or “calcining”) the support in a dry atmosphere at elevated temperature, preferably greater than 100° C., and more preferably from 150 to 800° C., prior to use. A variety of different chemical treatments can be used, including reaction with organo-aluminum, -magnesium, -silicon, or -boron compounds. See, for example, the techniques described in U.S. Pat. No. 6,211,311, the teachings of which are incorporated herein by reference.

With the catalyst system of the present invention it is possible to polymerize alpha-olefins in high yield to obtain polymers having high molecular weight. Thus a further object of the present invention is a process for polymerizing one or more alpha olefins of formula CH₂═CHT wherein T is hydrogen or a C₁-C₂₀ alkyl radical comprising the step of contacting said alpha-olefins of formula CH₂═CHT under polymerization conditions in the presence of the catalyst system described above.

Preferred α-olefins are ethylene, propylene, 1-butene, 1-hexene, 1-octene.

The catalyst system of the present invention is particularly fit for the polymerization of ethylene or copolymerization of ethylene and propylene, 1-butene, 1-hexene and 1-octene. Thus a further object of the present invention is a process for polymerizing ethylene and optionally one or more alpha olefins selected from propylene, 1-butene, 1-hexene and 1-octene comprising the step of contacting ethylene and optionally said alpha-olefins under polymerization conditions in the presence of the catalyst system described above.

Many types of olefin polymerization processes can be used. Preferably, the process is practiced in the liquid phase, which can include slurry, solution, suspension, or bulk processes, or a combination of these. High-pressure fluid phase or gas phase techniques can also be used. In a preferred olefin polymerization process, a supported catalyst of the invention is used. The polymerizations can be performed over a wide temperature range, such as −30° C. to 280° C. A more preferred range is from 30° C. to 180° C.; most preferred is the range from 60° C. to 100° C. Olefin partial pressures normally range from 15 psig to 50,000 psig. More preferred is the range from 15 psig to 1000 psig.

The invention includes a high-temperature solution polymerization process. By “high-temperature,” we mean at a temperature normally used for solution polymerizations, i.e., preferably greater than 130° C., and most preferably within the range of 135° C. to 250° C. The following examples merely illustrate the invention. Those skilled in the art will recognize many variations that are within the spirit of the invention and scope of the claims.

### EXAMPLES

All intermediate compounds and complexes synthesized give satisfactory ¹H NMR spectra consistent with the structures indicated.

### Preparation of Ligand 1

### 8-Bromoquinoline-2-carbaldehyde

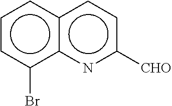

8-Bromoquinaldine (11 g, 50 mmol) is dissolved in a minimum amount of dioxane, and this solution is added at 80° C. to a mixture of dioxane (60 mL), water (2.5 mL), and selenium dioxide (7.0 g, 63 mmol). The reaction mixture stirs for 1 h at 80° C. and is then cooled to ambient temperature and filtered through a thin layer of silica. The solvent is removed under vacuum and the resulting product is used without further treatment.

### N-[(E)-(8-Bromoquinolin-2-yl)methylidene]-2,6-diisopropylaniline

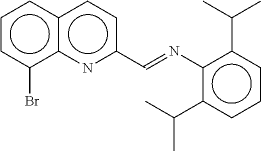

2,6-Diisopropylaniline (2.0 g, 11 mmol) and p-toluenesulfonic acid (50 mg) are added to a solution of 8-bromoquinoline-2-carbaldehyde (2.36 g, 10 mmol) in ethanol. The mixture is heated and refluxed for 2 min and cooled to ambient temperature. The precipitate is separated, washed with ethanol (5 mL), and dried under vacuum. Yield: 3.32 g (84%).

### 2-{(E)-[(2,6-Diisopropylphenyl)imino]methyl}-N-(2,6-dimethylphenyl)-8-quinolinamine

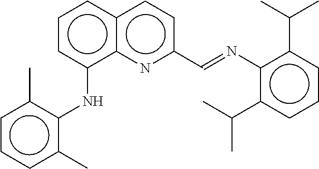

A mixture of N-[(E)-(8-bromoquinolin-2-yl)methylidene]-2,6-diisopropyl-aniline (1.0 g, 2.5 mmol), 2,6-dimethylaniline (0.40 g, 3.3 mmol), sodium tert-butoxide (0.5 g), toluene (5 mL), Pd(dba)₂ (30 mg) and (N-[2′-(dicyclohexylphosphino)[1,1′-biphenyl]-2-yl]-N,N-dimethylamine) (40 mg) is stirred at 105° C. for 4 h under argon. The product is purified using column chromatography (SiO₂, hexane-benzene 2:1). Yield: 0.70 g (64%).

### Preparation of Ligand Precursor 1

### 2-Acetyl-8-bromoquinoline

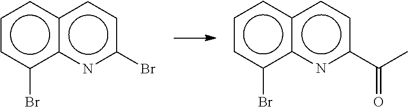

n-Butyllithium (32 mL of 2.5 M solution in hexanes, 80 mmol) is slowly added at −70° C. to a solution of ethylvinyl ether (16 mL, 160 mmol) in dry THF (140 mL). The solution is allowed to reach ambient temperature and stirring continues for an additional hour. The resulting solution is cooled to −70° C. followed by addition of anhydrous ZnCl₂ (10.9 g, 80 mmol), and the reaction mixture is again allowed to reach ambient temperature. A solution of catalysts (0.4 g of Pd(dba)₂ and 0.4 g of PPh₃ in 5 mL of THF) is first added to the resulting reaction mixture. This is stirred for 5 min., followed by addition of 2,8-dibromoquinoline (11.5 g, 40 mmol, prepared as described in Tetrahedron Lett. 46 (2005) 8419). The mixture stirs overnight and is then refluxed for 4 h. The resulting reaction mixture is treated with HCl (100 mL of 1 N solution) and is refluxed for an additional 4 h. The organic phase is separated, and the aqueous phase is extracted twice with diethyl ether. The combined organic phases are dried over anhydrous MgSO₄ and concentrated. The residue is dissolved in benzene and eluted through a short silica column. Removal of solvent results in 4.5 g of product (45% yield). ¹H NMR (CDCl₃): 8.24 (d, 1H); 8.14 (d, 1H); 8.09 (d, 1H); 7.81 (d, 1H); 7.47 (t, 1H); 2.94 (s, 3H).

### N-[(E)-1-(8-Bromo-2-quinolinyl)ethylidene]-2,6-bis(1-methylethyl)-benzenamine

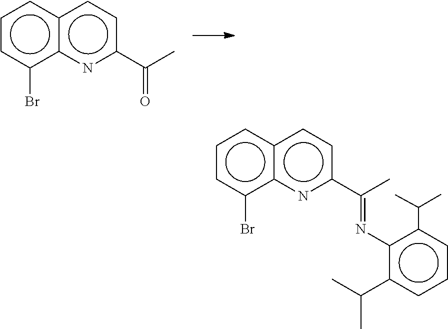

A mixture of 2-acetyl-8-bromoquinoline (2.5 g, 10 mmol), 2,6-diisopropylaniline (1.8 g, 10 mmol) and p-toluenesulfonic acid (0.1 g) is refluxed in ethanol (15 mL) for 3 h. The crystalline precipitate formed upon cooling is separated, washed with a small amount of ethanol, and dried (yield: 2.53 g, 62%). ¹H NMR (CDCl₃): 8.63 (d, 1H); 8.24 (d, 1H); 8.11 (d, 1H); 7.84 (d, 1H); 7.46 (t, 1H); 7.22 (m, 3H); 2.81 (m, 2H); 2.47 (s, 3H); 1.20 (dd, 12H).

### 2-[(1E)-1-[[2,6-Bis(1-methylethyl)phenyl]imino]ethyl]-N-(2,6-dimethylphenyl)-8-quinolinamine (Ligand 2)

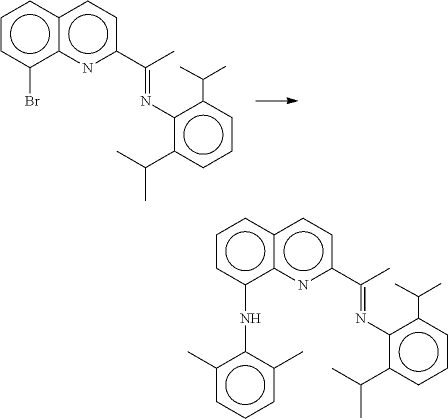

A mixture of (N-[(E)-1-(8-bromo-2-quinolinyl)ethylidene]-2,6-bis(1-methylethyl)benzenamine) (0.41 g, 1 mmol), 2,6-dimethylaniline (0.2 g, 1.6 mmol), toluene (5 mL), 20 mg of Pd(dba)₂, 40 mg of N-[2′-(dicyclohexylphoshino)(1,1′-biphenyl)-2-yl]-N,N-dimethylamine and sodium t-butoxide (0.15 g) is stirred for 6 h at 100-105° C. The resulting mixture is cooled to ambient temperature and treated with water. The organic layer is separated, while the aqueous phase is extracted with toluene (5 mL). The combined organic phases are dried (MgSO₄) and concentrated. The residue is purified on a silica column using hexane-benzene (1:1). Yield of precursor 1: 0.26 g (81%). ¹H NMR (CDCl₃): 8.57 (d, 1H); 8.22 (d, 1H); 7.71 (s, 1H); 7.35 (m, 2H); 7.20 (m, 6H); 6.35 (d, 1H); 2.84 (m, 2H); 2.39 (s, 3H); 2.33 (s, 6H); 1.21 (d, 12H).

### Catalyst Preparation

A 1:1 mole ratio of ligand precursor (0.07 mmol) and transition metal source are slurried in toluene (0.5 mL) at ambient temperature for 1 hour. A solution of trityl tetrakis(pentafluorophenyl)borate (0.09 mmol) in 2 mL of toluene is added to the complex slurry, and the mixture is stirred for 30 min. The mixture is added to Davison 948 silica (0.5 g, calcined 6 h at 600° C.), and the resulting free flowing powder is to polymerize ethylene as described below.

### Ethylene Polymerization

A reactor is charged with isobutane (1 L), 1-butene (100 mL), triisobutylaluminum (TIBAL) (1 mL of 1M solution; scavenger). A portion of catalyst indicated in table 1 is treated with an amount of trisobutylaluminum (1M solution) indicated in table 1 the resulting catalyst is added to start the reaction. Polymerization continues at 70° C. for 1 hour, supplying ethylene on demand to maintain the 15 bar partial pressure. The polymerization is terminated by venting the reactor, resulting in white, uniform polymer powder. The polymerization results are indicated in table 1.

TABLE 1

| | Ligand | Metal | Supp | TIBAL | Activity, | Branches/ | | |
|---|---|---|---|---|---|---|---|---|
| Ex. | precursor | source | cat. G | 1M ml | kg/mol/h | 1000 C. | MI2 | Er |
| 1 | 1 | ZrCl₄ | 0.300 | 0.05 | 2111 | 6.9 | 0.20 | 7.37 |
| 2 | 2 | ZrCl₄ | 0.150 | 0.02 | 5351 | 7.4 | 0.32 | 9.24 |

We claim:

1. A catalyst system obtainable with a process comprising the following steps:
i) contacting a group 4 metal compound of formula (I)
MX₄ (I)
wherein M is a metal of group 4 of the periodic table of the element, and X, equal to or different from each other, is a halogen atom, a R, OR, SR, NR₂ or PR₂ group wherein R is a linear or branched, cyclic or acyclic, C₁-C₄₀-alkyl, C₂-C₄₀ alkenyl, C₂-C₄₀ alkynyl, C₆-C₄₀-aryl, C₇-C₄₀-alkylaryl or C₇-C₄₀-arylalkyl radical; or two X groups can be joined together to form a divalent R′ group wherein R′ is a C₁-C₂₀-alkylidene, C₆-C₂₀-arylidene, C₇-C₂₀-alkylarylidene, or C₇-C₂₀-arylalkylidene divalent radical optionally containing heteroatoms belonging to groups 13-17 of the Periodic Table of the Elements;
with a compound of formula (II) 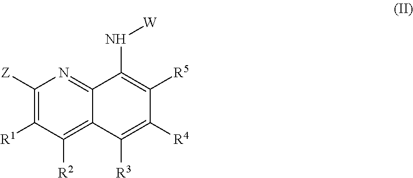
wherein:
W is a C₆-C₄₀-aryl radical that can be substituted with one or more G group wherein G, equal to or different from each other, are linear or branched C₁-C₄₀-alkyl, C₂-C₄₀ alkenyl, C₂-C₄₀ alkynyl radicals;
R¹, R², R³, R⁴ and R⁵, equal to or different from each other, are hydrogen atoms or C₁-C₄₀ hydrocarbon groups optionally containing one or more heteroatoms belonging to groups 13-17 of the Periodic Table of the Elements;
Z is selected from moiety of formula (IIa) or (IIb) 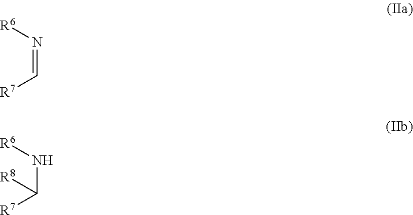
Wherein
R⁶ and R⁷ equal to or different from each other, are C₁-C₄₀ hydrocarbon groups optionally containing one or more heteroatoms belonging to groups 13-17 of the Periodic Table of the Elements; or R⁶ and R⁷ can be joined to form a a C₃-C₂₀ membered ring that can be aliphatic or aromatic and one or more carbon atoms of the ring can be optionally substituted with heteroatoms belonging to groups 13-16 of the Periodic Table of the Elements, and can have on its turn C₁-C₄₀ hydrocarbon substituents;
more preferably R₇ is a C₁-C₂₀-alkyl radical, such as methyl, ethyl, propyl, isopropyl, tert-butyl radical;
R⁸ is hydrogen atom or C₁-C₄₀ hydrocarbon groups optionally containing one or more heteroatoms belonging to groups 13-17 of the Periodic Table of the Elements; wherein the molar ratio between (I) and (II) are from 0.5 to 2, more preferably from 0.8 to 1.5, and most preferably from 0.9 to 1.1
ii) adding to the reaction mixture of step i) one or more boron compounds having Lewis acidity wherein the molar ratio between the boron compound and the compound of formula (I) ranges from 0.9 to 100;
iii) adding the reaction mixture obtained in step ii) to a support.
with the proviso that the catalyst system is not treated with alumoxanes.

2. The catalyst system according to claim 1 treated before the use with organo-aluminium compound of formula HⱼAlU₃₋ⱼ or HⱼAl₂U₆₋ⱼ, where the U substituents, same or different, are hydrogen atoms, halogen atoms, C₁-C₂₀-alkyl, C₃-C₂₀-cyclalkyl, C₆-C₂₀-aryl, C₇-C₂₀-alkylaryl or C₇-C₂₀-arylalkyl radicals, optionally containing silicon or germanium atoms, with the proviso that at least one U is different from halogen, and j ranges from 0 to 1, being also a non-integer number.

3. The catalyst system according to claim 1 wherein the boron compounds having Lewis acidity are selected from organoboranes, organoboronic acids, organoborinic acids

4. The catalyst system according to claim 1 wherein the compound of formula (II) has formula (IIIa) or (IIIb) 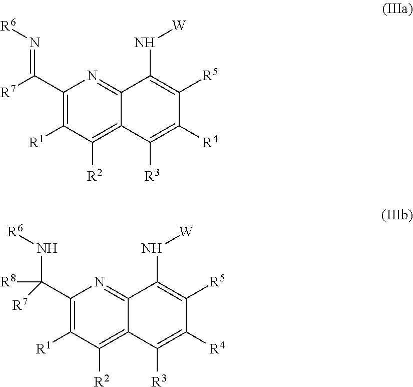
Wherein R¹, R², R³, R⁴, R⁵, R⁶, R⁷, R⁸ and W have been described in claim 1.

5. The catalyst system according to claim 1 wherein the compound of formula (II) has formula (IV) 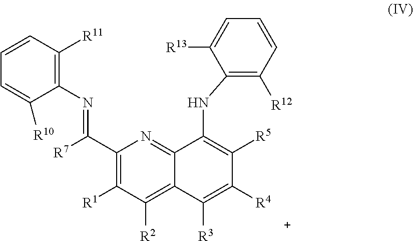
Wherein R¹, R², R³, R⁴, R⁵ have been described in claim 1 and R¹⁰, R¹¹, R¹² and R¹³, equal to or different from each other, are hydrogen atoms or C₁-C₂₀ alkyl radicals;

6. The catalyst system according to claim 1 wherein the support is selected from silica, alumina, silica-alumina, magnesia, titania, zirconia, clays, zeolites.

7. A process for polymerizing one or more alpha olefins of formula CH₂═CHT wherein T is hydrogen or a C₁-C₂₀ alkyl radical comprising the step of contacting said alpha-olefins of formula CH₂═CHT under polymerization conditions in the presence of the catalyst system of claim 1.

8. The polymerization process according to claim 1 for the polymerization of ethylene and optionally one or more alpha olefins selected from propylene, 1-butene, 1-hexene and 1-octene comprising the step of contacting ethylene and optionally said alpha-olefins under polymerization conditions in the presence of the catalyst system of claim 1.
